(19) United States
(12) Patent Application Publication
(10) Pub. No.: US 2021/0078294 A1
(43) Pub. Date: Mar. 18, 2021

(54) GLASS ARTICLE, METHODS FOR MANUFACTURING THE SAME, AND LASER WELDING EQUIPEMNT

(71) Applicant: SHENZHENSHI YUZHAN PRECISION TECHNOLOGY CO., LTD., Shenzhen (CN)

(72) Inventors: CHEN-YU HONG, New Taipei (TW); SHIH-HONG CHANG, New Taipei (TW); CHIN-HSIEN HUANG, New Taipei (TW)

(21) Appl. No.: 17/018,423

(22) Filed: Sep. 11, 2020

(30) Foreign Application Priority Data
Sep. 16, 2019 (CN) 201910872214.0
Sep. 16, 2019 (CN) 201910872215.5
Sep. 16, 2019 (CN) 201910872238.6

(51) Int. Cl. B32B 17/10; B32B 7/12; B32B 27/26

(52) U.S. Cl. CPC B32B 17/10036; B32B 7/12; B32B 27/26; B32B 17/10706; B32B 2310/0843; B32B 17/10954; B32B 2250/04; B32B 2305/72; B32B 2309/06; B32B 17/10917

(57) ABSTRACT

A glass article without cracks includes a first glass, a second glass, and a bonding layer located between and connecting the first glass and the second glass. A method for manufacturing a glass article includes fixing and holding a first glass and a second glass, and irradiating the first glass and the second glass with a laser beam to form a bonding layer between two surfaces of the first glass and the second glass, the bonding layer connecting with the first glass and the second glass. The disclosure further provides a laser welding equipment for combining the first glass and the second glass.

### CROSS-REFERENCE TO RELATED APPLICATIONS

This application claims all benefits accruing under 35 U.S.C. § 119 from China Patent Application No. 201910872214.0, filed on Sep. 16, 2019, China Patent Application No. 201910872238.6, filed on Sep. 16, 2019, and China Patent Application No. 201910872215.5, filed on Sep. 16, 2019, in the China Intellectual Property Administration, the entire contents of which are incorporated herein by reference.

### FIELD

The subject matter herein generally relates to a glass article, methods for manufacturing the glass article, and laser welding equipment.

### BACKGROUND

In industrial applications, it may be necessary to combine two or more glass parts to form a glass article. But defects emerge during the manufacture of the glass article, such as uneven appearance, bubbles between the glass parts, different transmittance in the different part of the article. Due to these defects, it's difficult to manufacture the glass article fulfilling the industrial requirements. A glass article with uniform appearance and high transmittance is need.

### SUMMARY

In view of the above situation, it is necessary to provide a glass article, a method for manufacturing the glass article, and a laser welding equipment to resolve the above-mentioned problems.

According to some embodiments, a glass article includes a first glass, a second glass, and a bonding layer located between the first glass and the second glass in a direction of a cross-section of the first glass. The first glass connects with the bonding layer, and the second glass connects with the bonding layer.

According to some embodiments, a glass article includes a first glass, a second glass, and a bonding layer located between the first glass and the second glass. The bonding layer includes an organic substance, and the first glass connects with the bonding layer, and the second glass connects with the bonding layer.

According to some embodiments, a glass article includes a first glass, a second glass, and a first area. The first area includes a bonding layer and a welding layer, the bonding layer is located between the first glass and the second glass in the direction of the cross-section of the first glass. The welding layer is located between the first glass and the second glass in the direction of the cross-section of the first glass, and the welding layer is located between the bonding layer and an edge of the first glass in a direction perpendicular to the cross-section of the first glass. The first glass connects with the bonding layer, and the second glass connects with the bonding layer.

According to some embodiments, a method for manufacturing a glass article combines a first glass and a second glass and includes: fixing the first glass and the second glass, a first surface of the first glass faces a second surface of the second glass; irradiating the first glass and the second glass with a laser beam to form a bonding layer between the first surface and the second surface in a direction of a cross-section of the first glass, the bonding layer connecting with the first glass and the second glass to form the glass article.

According to some embodiments, a method for manufacturing a glass article includes combining a first glass and a second glass, and the method includes: providing an organic substance on at least one of the first surface and the second surface; fixing the first glass and the second glass, a first surface of the first glass faces a second surface of the second glass, and the organic substance being located between the first glass and the second glass; irradiating the first glass and the second glass with a laser beam to form a bonding layer between the first surface and the second surface, the bonding layer connects with the first glass and the second glass, thereby forming the glass article.

According to some embodiments, a method for manufacturing a glass article combines a first glass and a second glass and includes: fixing the first glass and the second glass, a first surface of the first glass faces a second surface of the second glass; irradiating the first glass and the second glass with a laser beam to form a welding layer and a bonding layer between the first surface and the second surface, the welding layer being located between the bonding layer and an edge of the first glass in a direction perpendicular to the cross-section of the first glass, and the bonding layer connects with the first glass and the second glass; defining a second area and a third area, the second area including the bonding layer, the third area including the welding layer, and the third area being located between the second area and the edge of the first glass in a direction perpendicular to the cross-section of the first glass; and cutting the third area to form the glass article.

According to some embodiments, a laser welding equipment for combining a first glass and a second glass includes a fixing device and a laser emitting device. The fixing device fixes the first glass and the second glass, so that a first surface of the first glass faces a second surface of the second glass. The laser emitting device is configured to emit a laser beam which penetrates through the first glass and the second glass to form a bonding layer between the first surface and the second surface, the bonding layer connects with the first glass and the second glass. The laser emitting device includes a femtosecond laser emitting tube.

According to an embodiment, a laser welding equipment configured to combine a first glass and a second glass includes an organic substance providing device, a fixing device, and a laser emitting device. The organic substance providing device provides an organic substance to at least one of a first surface of the first glass and a second surface of the second glass. The fixing device fixes the first glass and the second glass, so that a first surface of the first glass faces a second surface of the second glass, the organic substance being located between the first glass and the second glass. The laser emitting device is configured to emit a laser beam which penetrates through the first glass and the second glass to form a bonding layer between the first surface and the second surface in a direction of a cross-section of the first glass, the bonding layer connects with the first glass and the second glass. The laser emitting device includes a femtosecond laser emitting tube.

According to some embodiments, a laser welding equipment combining a first glass and a second glass includes a fixing device, a laser emitting device, and a cutting device. The fixing device is configured to fix the first glass and the second glass, so that a first surface of the first glass faces a second surface of the second glass. The laser emitting device is configured to emit a laser beam which penetrates through the first glass and the second glass to form a welding layer and a bonding layer between the first surface and the second surface, the bonding layer connects with the first glass and the second glass, the welding layer being located between the bonding layer and an edge of the first glass in a direction perpendicular to the cross-section of the first glass. The cutting device is configured to cut a third area between a second area and an edge of the glass to form a glass article, the second area including the bonding layer. The laser emitting device includes a femtosecond laser emitting tube.

In related art, a glass product may be produced by a glass fusion method, there is only a physical change of the molecular in the fusion part of the glass product. However, in the method for manufacturing the glass article of the present disclosure, a bonding structure is formed between glasses, the chemical bonds of the atoms in the glasses are broken and then re-formed due to a multiphoton absorption effect generated by a laser during the manufacture. The resulting microscopic appearance of the glasses is flat, and the welding marks are small. According to an embodiment, the organic substance is provided on the first surface of the first glass and the second surface of the second glass, the compound fills the micron-scale gaps between unevenness of the first surface of the first glass and the second surface of the second glass. The compound replaces the air in the micron-scale gaps, which reduces the light refraction when the laser beam penetrates through the first glass and the second glass. The glass article of the present disclosure is welded firmly without welding cracks, and the welding effect is good. According to an embodiment, the welding layer between the bonding layer and an edge of the first glass helps to fix the first glass and the second glass before forming the bonding layer, and the bonding layer connects with the first glass and the second glass. Providing the welding layer between the bonding layer and an edge of the first glass improves a stability of the first glass and the second glass during the formation of the bonding layer, so that the first glass and the second glass are firmly bonded.

### BRIEF DESCRIPTION OF THE DRAWINGS

Implementations of the present technology will now be described, by way of embodiment, with reference to the attached figures.

FIG. 1 illustrates a diagrammatic view of a glass article, in accordance with an embodiment.

FIG. 2 illustrates a cross-sectional view along line B-B of FIG. 1.

FIG. 3 illustrates an enlarged view of circled area III in FIG. 2.

FIG. 4 illustrates a cross-sectional view along line A-A of FIG. 1, in accordance with a first embodiment.

FIG. 5 illustrates a cross-sectional view along line A-A of FIG. 1, in accordance with a second embodiment.

FIG. 6 illustrates a cross-sectional view along line A-A of FIG. 1, in accordance with a third embodiment.

FIG. 7 illustrates a diagrammatic view of a glass article, in accordance with another embodiment.

FIG. 8 illustrates a cross-sectional view along line B-B of FIG. 7.

FIG. 9 illustrates an enlarged view of circled area III in FIG. 8.

FIG. 10 illustrates a top view of the glass article of FIG. 7.

FIG. 11 illustrates a flowchart of a method for manufacturing a glass article in accordance with one embodiment.

FIG. 12 illustrates a flowchart of a method for manufacturing a glass article in accordance with another embodiment.

FIG. 13 illustrates a flowchart of a method for manufacturing a glass article in accordance with yet another embodiment.

FIG. 14 illustrates a diagrammatic view of a bonding layer and a welding layer formed on a first glass and a second glass.

FIG. 15 illustrates a diagrammatic view showing a second area and a third area of a first glass and a second glass in accordance with an embodiment.

FIG. 16 illustrates a diagrammatic view of a glass article formed by cutting the third area of FIG. 15.

FIG. 17 illustrates a diagrammatic view showing a second area and a third area of a first glass and a second glass in accordance with another embodiment.

FIG. 18 illustrates a diagrammatic view of a glass article formed by cutting the third area of FIG. 17.

FIG. 19 illustrates a flowchart of forming the bonding layer located between the first glass and the second glass by laser.

FIG. 20 illustrates a diagrammatic view of a laser welding equipment in accordance with an embodiment.

### DETAILED DESCRIPTION

Implementations of the disclosure will now be described, by way of embodiments only, with reference to the drawings. The disclosure is illustrative only, and changes may be made in the detail within the principles of the present disclosure. It will, therefore, be appreciated that the embodiments may be modified within the scope of the claims.

Unless otherwise defined, all technical terms used herein have the same meaning as commonly understood by one of ordinary skill in the art. The technical terms used herein are to provide a thorough understanding of the embodiments described herein but are not to be considered as limiting the scope of the embodiments.

The following describes the technical solutions in the embodiments of this application with reference to the accompanying drawings in the embodiments of this application. It should be noted that the technical solutions or features in the embodiments of this application may be mutually combined in the case of no conflict.

In some related techniques, the glass parts are combined by a glass fusion method, which may include a hot flame melting method, an adhesive bonding and heat absorption method, a hot pressing method, a hot melting method, and the like. The hot flame melting method may cause uneven appearance, generation of bubbles, and uneven light transmittance of the glass article. Adhesive bonding may cause problems such as poor flatness, poor bonding density, and uneven light transmittance of the glass article due to the presence of adhesives. Methods such as heat absorption, hot pressing, and hot melting have problems such as short mold life, and high requirements for temperature control and vacuum control.

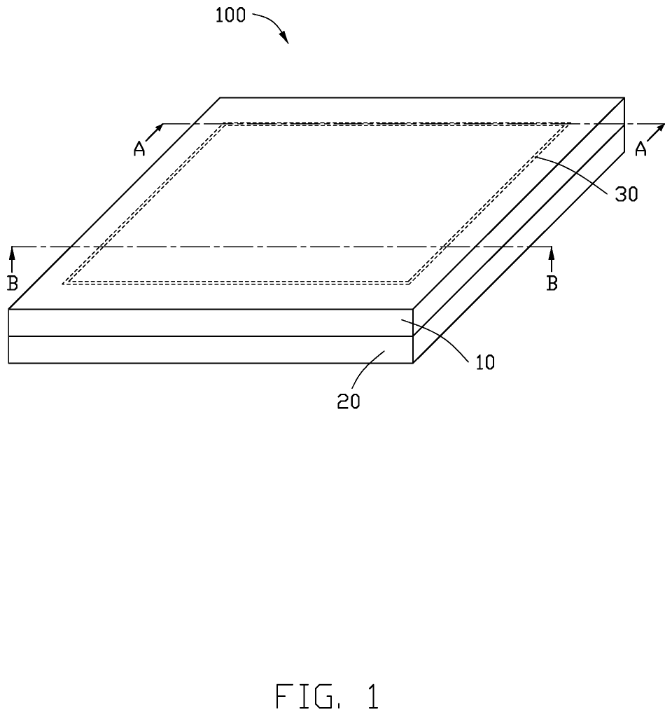

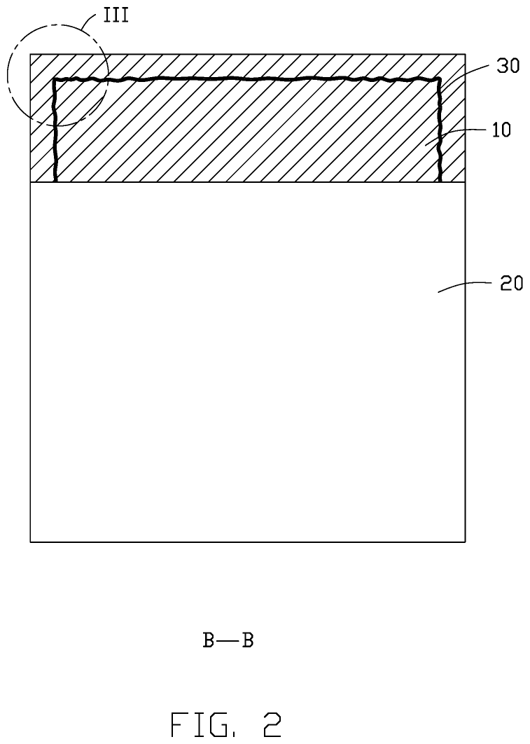

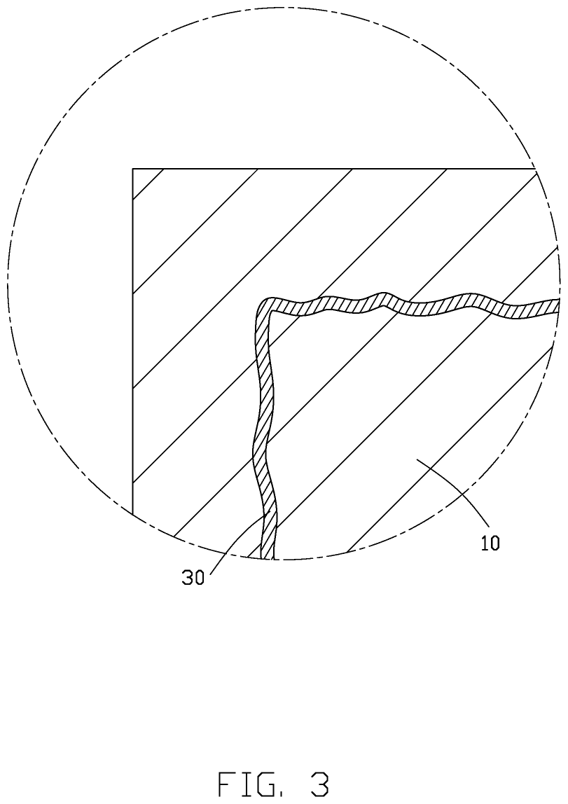

FIGS. 1 to 4 illustrate embodiments of a glass article 100, which includes a first glass 10, a second glass 20, and a bonding layer 30. The bonding layer 30 is located between the first glass 10 and the second glass 20. The first glass 10 connects with the bonding layer 30, and the second glass 20 connects with the bonding layer 30.

The first glass 10 includes a first surface 11, the second glass 20 includes a second surface 21, and the first surface 11 faces the second surface 21.

Through the ultra-short timed pulses of the laser, molecules of the first glass 10 and the second glass 20 obtain instant energy, the energy is sufficient to exceed the bond breaking energy of Si—Si or Si—O—Si or SiO—OSi to achieve a multi-photon absorption effect, new covalent bonds form during the multi-photon absorption effect reaction, thereby forming the bonding layer 30. The first glass 10 is thereby bonded to the second glass 20 by diffusion bonding.

The bonding layer 30 may be determined by the following methods.

X-ray photoelectron spectroscopy/electron spectroscopy for chemical analysis (XPS/ESCA) can detect qualitative and quantitative information, and energy state information of elements. Energy loss spectroscopy (EELS) can analyze compositions, chemical bonds, and electronic structures of elements in a microscopically-small area of a thin sample. Infrared absorption spectroscopy (IR) method can perform qualitative analysis and quantificational analysis of functional groups.

The size information of the bonding layer 30 can be determined by using a scanning electron microscope (SEM) to scan a cross-section of the glass article 100.

A straight-line distance between a center of a first bonding unit 31 and a center of a second bonding unit 32 is a, and 5 μm≤a≤1000 μm. According to an embodiment, the lower limit of a is one selected from the group consisting of 6 μm, 7 μm, 9 μm, 15 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, and 900 μm. The upper limit of a is one selected from the group consisting of 7 μm, 10 μm, 13 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, and 950 μm. The lower limit must be not greater than the upper limit.

When the straight-line distance a is less than 5 um, cracks are likely to occur; when the straight-line distance a is greater than 5 um, there is likely to be insufficient bonding.

A thickness of the bonding layer 30 in the first glass 10 is b, and 0<b≤90% of a thickness of the first glass 10. According to an embodiment, the lower limit of b is one selected from the group consisting of 1%, 3%, 5%, 7%, 9%, 10%, 15%, 20%, 25%, 30%, 35%, 40%, 45%, 50%, 55%, 60%, 65%, 70%, 75%, 80%, and 85%. The upper limit of b is one selected from the group consisting of 2%, 4%, 6%, 8%, 10%, 12%, 18%, 22%, 28%, 33%, 35%, 40%, 45%, 50%, 55%, 60%, 65%, 70%, 75%, 80%, and 85%. The lower limit must be not greater than the upper limit. The bonding layer 30 in the first glass 10 must have enough thickness to achieve the bonding effect, so the b must be greater than 0. The b must be not greater than 90% of the thickness of the first glass 10, if b being greater than 90% of the thickness of the first glass 10 will cause cracks in the first glass 10.

The scope of the thickness b of the bonding layer 30 in the first glass 10 is 0 μm<b≤2000 μm. According to an embodiment, the lower limit of b is one selected from the group consisting of 6 μm, 7 μm, 9 μm, 15 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, 900 μm, 1000 μm, 1050 μm, 1200 μm, 1250 μm, 1300 μm, 1350 μm, 1400 μm, 1500 μm, 1600 μm, 1700 μm, 1800 μm, and 1900 μm. According to an embodiment, the upper limit of b is one selected from the group consisting of 8 μm, 10 μm, 13 μm, 19 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, 900 μm, 1000 μm, 1050 μm, 1200 μm, 1250 μm, 1300 μm, 1350 μm, 1450 μm, 1550 μm, 1650 μm, 1750 μm, 1850 μm, and 1950 μm. The lower limit must be not greater than the upper limit.

The bonding layer 30 in the first glass 10 must have enough thickness to achieve the bonding effect, so the b must be greater than 0. The b must be not greater than 90% of the thickness of the first glass 10, if b being greater than 90% of the thickness of the first glass 10 will cause cracks in the first glass 10.

A thickness of the bonding layer 30 in the second glass 20 is c, and 0<c≤90% of a thickness of the second glass 20. According to an embodiment, the lower limit of c is one selected from the group consisting of 1%, 3%, 5%, 7%, 9%, 10%, 15%, 20%, 25%, 30%, 35%, 40%, 45%, 50%, 55%, 60%, 65%, 70%, 75%, 80%, and 85%.

According to an embodiment, the upper limit of c is one selected from the group consisting of 2%, 4%, 6%, 8%, 10%, 12%, 18%, 22%, 28%, 33%, 35%, 40%, 45%, 50%, 55%, 60%, 65%, 70%, 75%, 80%, and 85%. The lower limit must be not greater than the upper limit. The bonding layer 30 in the second glass 20 must have enough thickness to achieve the bonding effect, so the c must be greater than 0. The c must be not greater than 90% of the thickness of the second glass 20, if c being greater than 90% of the thickness of the second glass 20 will cause cracks in the second glass 20.

The scope of the thickness c of the bonding layer 30 in the second glass 20 is 0 μm<c≤2000 μ. According to an embodiment, the lower limit of c is one selected from the group consisting of 6 μm, 7 μm, 9 μm, 15 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, 900 μm, 1000 μm, 1050 μm, 1200 μm, 1250 μm, 1300 μm, 1350 μm, 1400 μm, 1500 μm, 1600 μm, 1700 μm, 1800 μm, and 1900 μm. According to an embodiment, the upper limit of c is one selected from the group consisting of 8 μm, 10 μm, 13 μm, 19 μm, 20 μm, 30 μm, 50 μm, 70 μm, 90 μm, 100 μm, 150 μm, 200 μm, 250 μm, 300 μm, 350 μm, 400 μm, 500 μm, 600 μm, 700 μm, 800 μm, 900 μm, 1000 μm, 1050 μm, 1200 μm, 1250 μm, 1300 μm, 1350 μm, 1450 μm, 1550 μm, 1650 μm, 1750 μm, 1850 μm, and 1950 μm. The lower limit must be not greater than the upper limit.

The bonding layer 30 in the second glass 20 must have enough thickness to achieve the bonding effect, so the c must be greater than 0. The c must be not greater than 90% of the thickness of the second glass 20, if c being greater than 90% of the thickness of the second glass 20 will cause cracks on the second glass 20.

According to an embodiment, the glass article 100 includes the first glass 10, the second glass 20, and the bonding layer 30 located between the first glass 10 and the second glass 20 in the direction of the cross-section of the first glass. The bonding layer 30 connects with the first glass 10, the bonding layer 30 connects with the second glass 20, and the bonding layer 30 includes an organic substance.

According to an embodiment, a ratio of a refractive index of the organic substance to a refractive index of the first glass 10 is X, and 80%≤X≤120%.

The upper limit of X is one selected from the group consisting of 119%, 115%, 110%, 105%, 100%, 95%, 90%, 85%, and 81%. The lower limit of X is one selected from the group consisting of 117%, 114%, 109%, 106%, 101%, 96%, 91%, 88%, and 83%. The lower limit must be not greater than the upper limit.

According to an embodiment, a ratio of a refractive index of the organic substance to a refractive index of the second glass 20 is Y, and 80%≤Y≤20%.

The upper limit of Y is one selected from the group consisting of 119%, 115%, 110%, 105%, 100%, 95%, 90%, 85%, and 81%. The lower limit of Y is one selected from the group consisting of 117%, 114%, 109%, 106%, 101%, 96%, 91%, 88%, and 83%. The lower limit must be not greater than the upper limit.

According to an embodiment, the organic substance includes an organic liquid with a carbon number not greater than 10. The organic liquid is not limited to one organic compound, and it can be a mixture of several organic compounds.

The upper limit of the carbon number of the organic liquid is one selected from the group consisting of 1, 2, 3, 5, 6, 7, and 9, and the lower limit of the carbon number of the organic liquid is one selected from the group consisting of 2, 3, 4, 6, 7, and 8. The lower limit must be not greater than the upper limit.

The organic liquid with a carbon number not greater than 10 is chosen because the organic liquid needs to be easily vaporized when heated, so that the two glasses can be bonded together during laser welding. The organic liquid with a carbon number not greater than 10 is suitable for welding in this way, and it can be vaporized by heat during laser welding without affecting the performance of glass article.

According to an embodiment, the organic substance includes at least one selected from ketones, alcohols, alkanes, benzenes, ethers, acids, acid anhydrides, esters, alkenes, alkynes, and liquid crystals.

According to an embodiment, a content of the organic substance is A, and 8×10⁻⁷ g/mm²≤A≤1×10⁻⁴ g/mm². According to an embodiment, the lower limit of A is one selected from 9×10⁻⁷ g/mm², 1×10⁻⁶ g/mm², 3×10⁻⁶ g/mm², 5×10⁻⁶ g/mm², 8×10⁻⁶ g/mm², 1×10⁻⁵ g/mm², 2×10⁻⁵ g/mm², 5×10⁻⁵ g/mm², 7×10⁻⁵ g/mm², and 9×10⁻⁵ g/mm². The upper limit of A is one selected from 9.5×10⁻⁷ g/mm², 1.5×10⁻⁶ g/mm², 2×10⁻⁶ g/mm², 4×10⁻⁶ g/mm², 9×10⁻⁶ g/mm², 1×10⁻⁵ g/mm², 3×10⁻⁵ g/mm², 6×10⁻⁵ g/mm², 8×10⁻⁵ g/mm², 9×10⁻⁵ g/mm². The lower limit must be not greater than the upper limit.

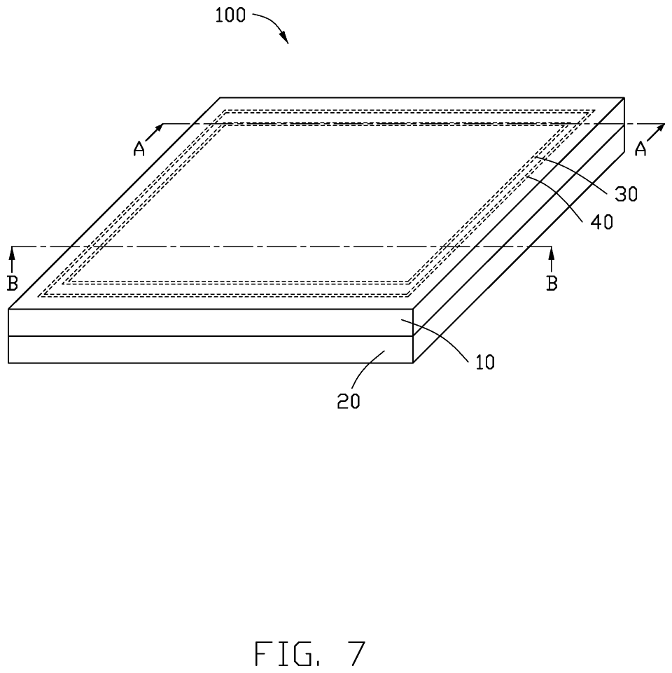

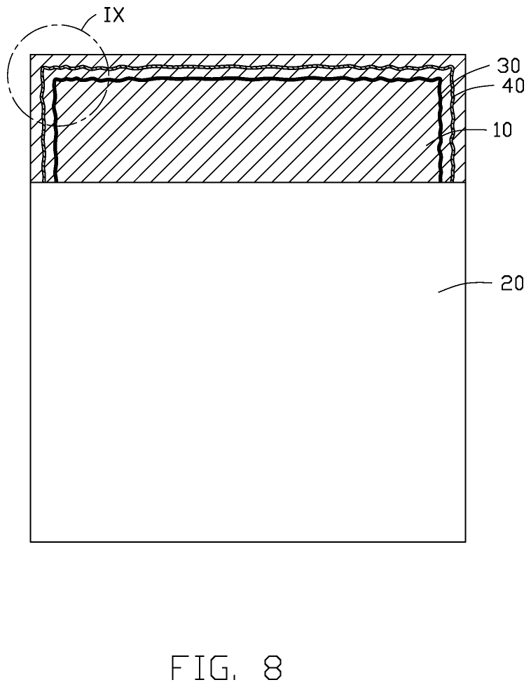

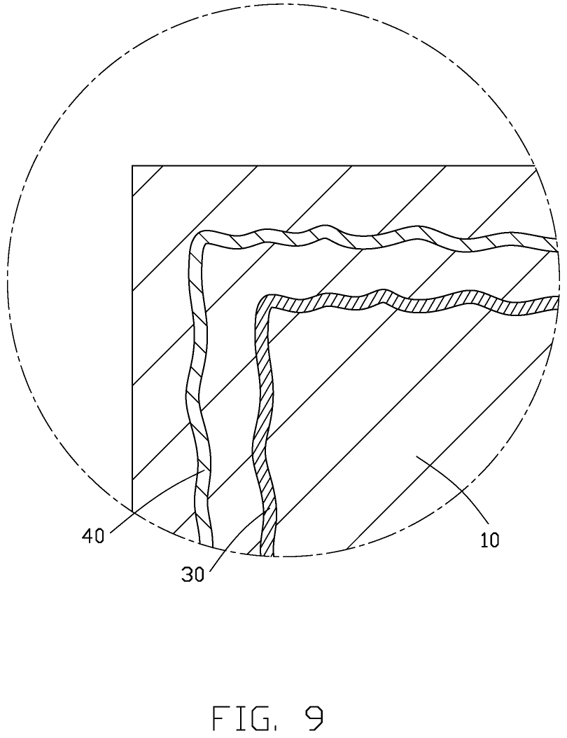

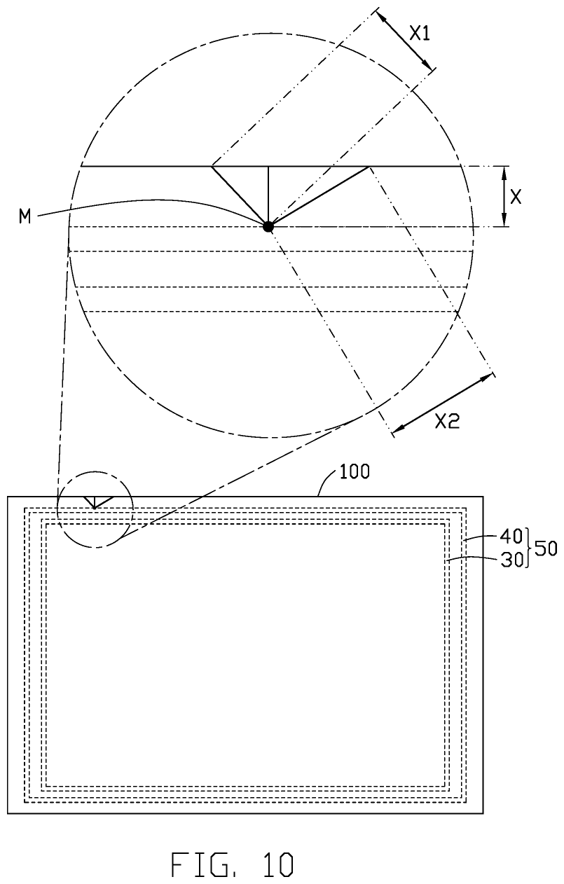

FIGS. 7 to 10 illustrate an embodiment of the glass article 100 including the first glass 10, the second glass 20, and a first area 50. The first area 50 is located between the first glass 10 and the second glass 20. The first area 50 includes the bonding layer 30 and a welding layer 40.

The bonding layer 30 is located between the first glass 10 and the second glass 20, and connects with the first glass 10 and the second glass 20. The welding layer 40 is located between edges of the first glass 10 and the bonding layer 30, and encases the bonding layer 30. The welding layer 40 may be arranged next to the bonding layer 30 or spaced apart from the bonding layer 30. The welding layer 40 may be arranged next to an edge of the first glass 10 or spaced apart from the edge of the first glass 10. A straight-line distance between any one point on the welding layer 40 and each point on the edge of the first glass 10 is x1, x2, xn (n is a integer value, n>2), and x is the smallest distance of x1, x2, and xn. The x is the shortest straight-line distance between the welding layer 40 and the edge of the first glass 10, and 0 μm≤x≤1000 μm.

The welding layer 40 is configured to fix the first glass 10 and the second glass 20 before forming the bonding layer 30. According to an embodiment, the lower limit of x is one selected from 0.5 μm, 1 μm, 1.5 μm, 2 μm, 2.5 μm, 3 μm, 3.5 μm, 4 μm, 4.5 μm, 5 μm, 5.5 μm, 8 μm, 9 μm, 10 μm, 15 μm, 20 μm, 25 μm, 30 μm, 35 μm, 40 μm, 45 μm, 50 μm, 55 μm, 70 μm, 80 μm, 90 μm, 100 μm, 150 μm, 200 μm, 250 μm, 300 μm, 350 μm, 400 μm, 450 μm, 500 μm, 550 μm, 600 μm, 650 μm, 700 μm, 750 μm, 800 μm, 850 μm, 900 μm, and 950 μm. The upper limit of x is one selected from 0.7 μm, 1 μm, 1.7 μm, 2 μm, 2.8 μm, 3 μm, 3.9 μm, 4 μm, 4.9 μm, 5 μm, 5.7 μm, 6 μm, 8 μm, 10 μm, 14 μm, 22 μm, 27 μm, 30 μm, 35 μm, 40 μm, 45 μm, 60 μm, 65 μm, 75 μm, 82 μm, 95 μm, 120 μm, 180 μm, 220 μm, 280 μm, 320 μm, 380 μm, 420 μm, 480 μm, 520 μm, 580 μm, 620 μm, 680 μm, 720 μm, 780 μm, 820 μm, 880 μm, 920 μm, and 980 μm. The lower limit must be not greater than the upper limit.

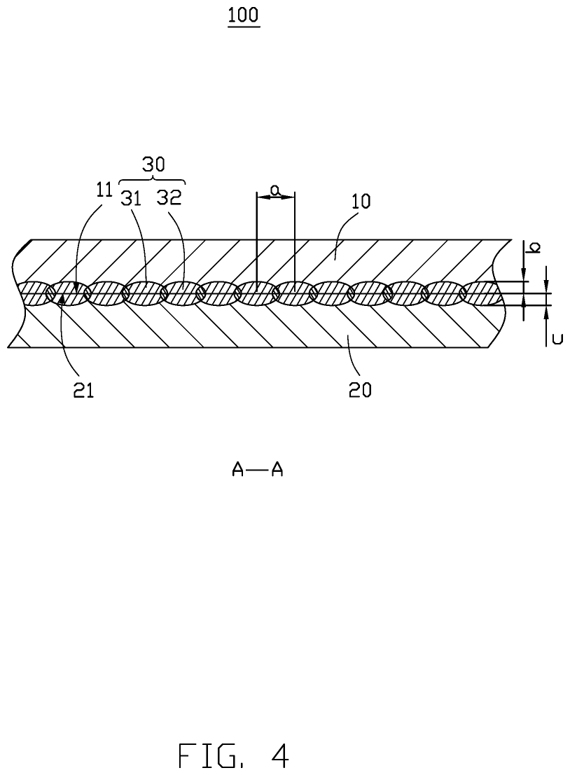

As FIGS. 4 to 6 illustrate, depending on the focus and path of the laser, the shapes and positions of the first bonding units 31, 231, 331 and the second bonding units 32, 232, 332 of the bonding layers 30, 230, 330 are slightly different.

As FIG. 4 illustrates, the bonding layer 30 in a first embodiment includes a first bonding unit 31 and a second bonding unit 32. The first bonding unit 31 and the second bonding unit 32 are both substantially elliptical, with their major axes parallel to the first surface 11 and the second surface 21. The first bonding unit 31 is partially overlapped with the second bonding unit 32.

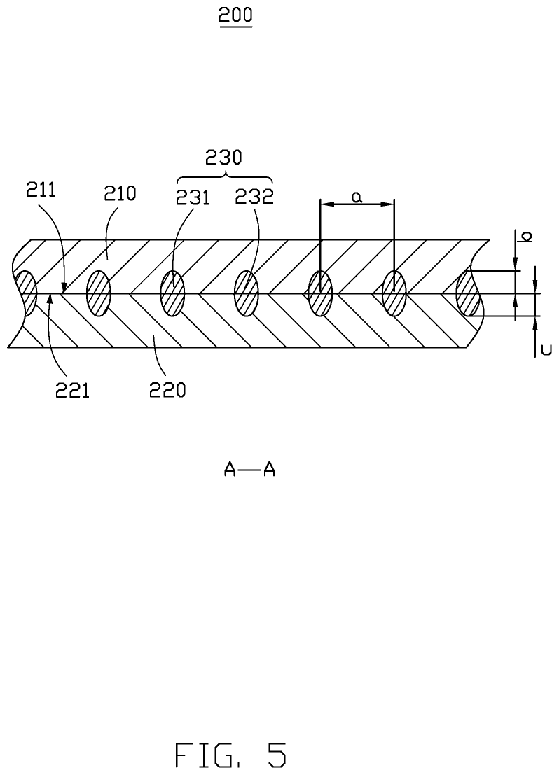

As FIG. 5 illustrates, a glass article 200 in a second embodiment includes a first glass 210, a second glass 220, and a bonding layer 230. The bonding layer 230 includes a first bonding unit 231 and a second bonding unit 232. The first bonding unit 231 and the second bonding unit 232 are both substantially elliptical, with their major axes perpendicular to a first surface 211 of the first glass 210 and a second surface 221 of the second glass 220. The first bonding unit 231 is not overlapped with the second bonding unit 232.

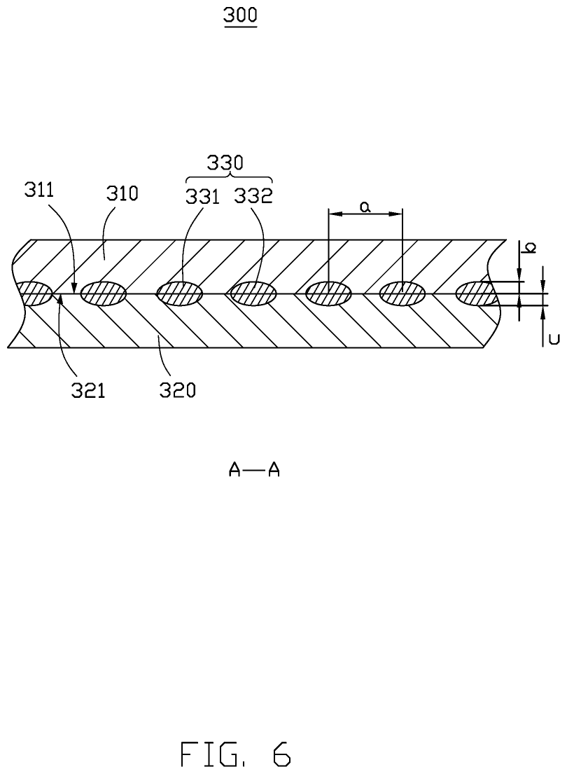

As FIG. 6 illustrates, a glass article 300 in a third embodiment includes a first glass 310, a second glass 320, and a bonding layer 330. The bonding layer 330 includes a first bonding unit 331 and a second bonding unit 332. The first bonding unit 331 and the second bonding unit 332 are both substantially elliptical, with their major axes parallel to a first surface 311 of the first glass 310 and a second surface 321 of the second glass 320. The first bonding unit 331 is not overlapped with the second bonding unit 332.

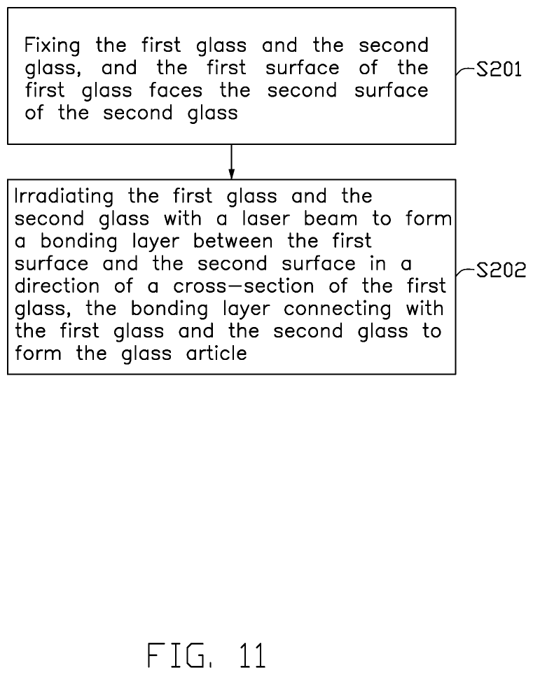

As FIG. 11 illustrates, a method for manufacturing the glass article 100 combines the first glass 10 and the second glass 20 together, and includes the steps of:

S201, fixing the first glass 10 and the second glass 20, and the first surface 11 of the first glass 10 faces the second surface 21 of the second glass 20; and

S202, irradiating the first glass 10 and the second glass 20 with a laser beam to generate a bonding structure between the first surface 11 and the second surface 21, the bonding structure is the bonding layer 30, the bonding layer 30 connecting with the first glass 10 and the second glass 20, and forming the glass article 100.

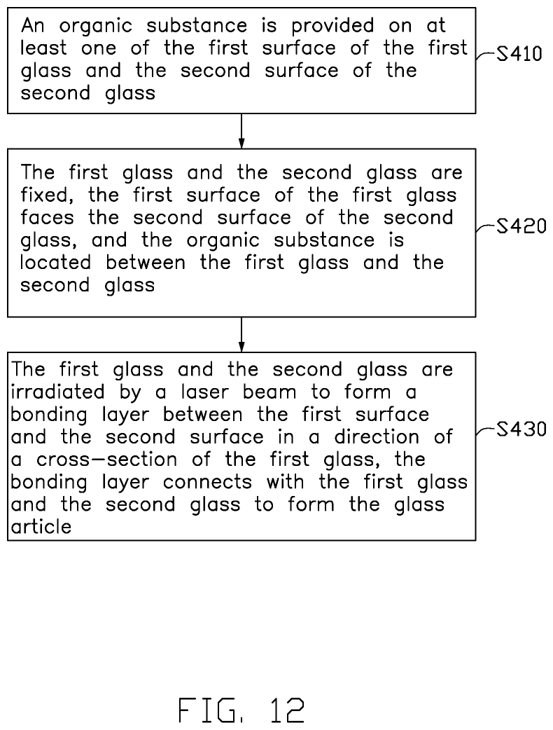

According to an embodiment, as FIG. 12 illustrates, a method for manufacturing the glass article 100 combines the first glass 10 and the second glass 20, and includes the following steps.

S410, an organic substance is provided on at least one of the first surface 11 of the first glass 10 and the second surface 21 of the second glass 20.

Specifically, a micron-scale atomizer is used to atomize the organic substance and provide the atomized organic substance to at least one of the first surface 11 and the second surface 21.

S420, the first glass 10 and the second glass 20 are fixed, the first surface 11 of the first glass 10 faces the second surface 21 of the second glass 20, and the organic substance is located between the first glass 10 and the second glass 20.

Specifically, the first glass 10 and the second glass 20 are fixed by a fixing device.

S430, the first glass 10 and the second glass 20 are irradiated by a laser beam to generate a bonding structure between the first surface 11 and the second surface 21 to form the bonding layer, the bonding layer connects with the first glass 10 and the second glass 20, thereby forming the glass article 100.

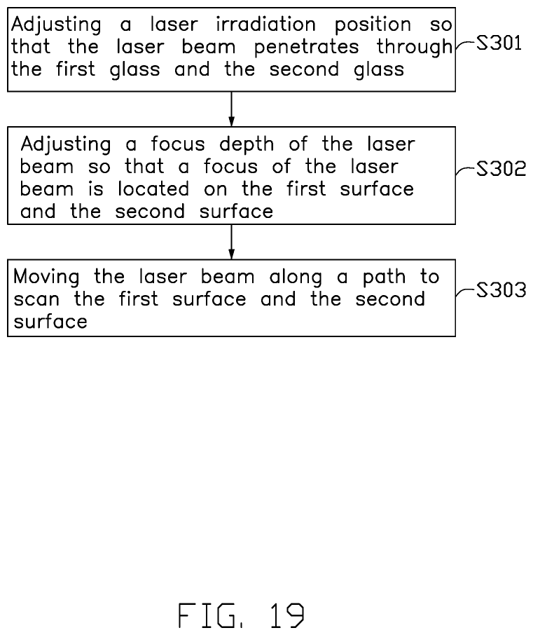

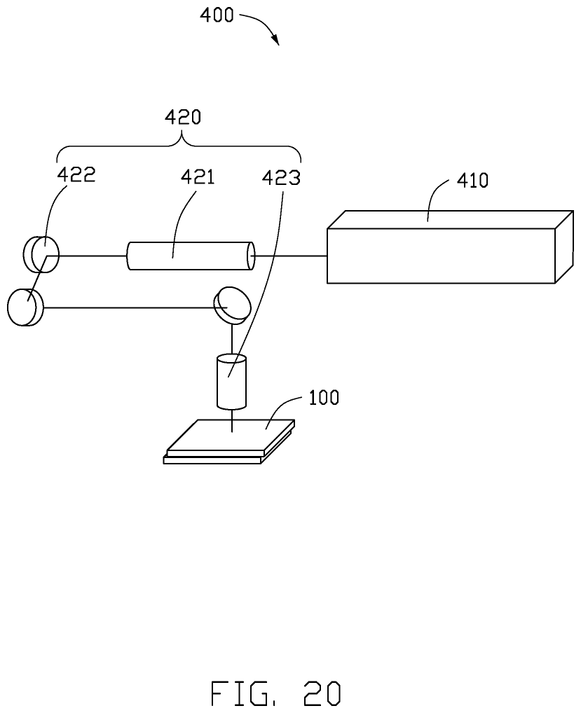

Specifically, the laser beam is emitted from a laser emitting device 400 (shown in FIG. 20). As FIG. 19 illustrates, the method of irradiating the first glass 10 and the second glass 20 with a laser beam includes the steps of:

S301, adjusting a laser irradiation position so that the laser beam penetrates through the first glass 10 and the second glass 20;

S302, adjusting a focus depth of the laser beam so that the focus of the laser beam is located on the first surface 11 and the second surface 21;

S303, moving the laser beam along a path to scan the first surface 11 and the second surface 21, so that a bonding structure is generated between the first surface 11 and the second surface 21 to form the bonding layer 30 connecting the first glass 10 and the second glass 20, the glass article 100 is thereby formed. It should be noted that, the sequence of steps S301, S302, and S303 can be adjusted according to needs, and there is no specific limitation. According to an embodiment, the focus of the laser beam may be located on the first surface 11 and the second surface 21 at the same time, thereby forming a bonding structure between the two surfaces. According to other embodiments, the focus of the laser beam is on the first surface 11 first, and then on the second surface 21 after a short period of time, thereby forming a bonding structure between the two surfaces.

In the glass article 100 and a method for manufacturing it, the first surface 11 of the first glass 10 and the second surface 21 of the second glass 20 are irradiated by a laser beam to form the bonding layer. The organic substance is provided on the first surface 11 of the first glass 10 and the second surface 21 of the second glass 20, which fills the microscopic gaps between the unevenness of the first surface 11 of the first glass 10 and the second surface 21 of the second glass 20, that reduces the light refraction when the laser beam penetrates through the first glass 10 and the second glass 20. The glass article 100 of the present disclosure is welded firmly and completely without cracks.

According to an embodiment, laser welding is a material-free welding process, and the unevenness of the glass itself is in fact a gap between two glasses, that is the upper glass and lower glass cannot be fully contacted with each other during laser welding, which affects a stability of the laser welding.

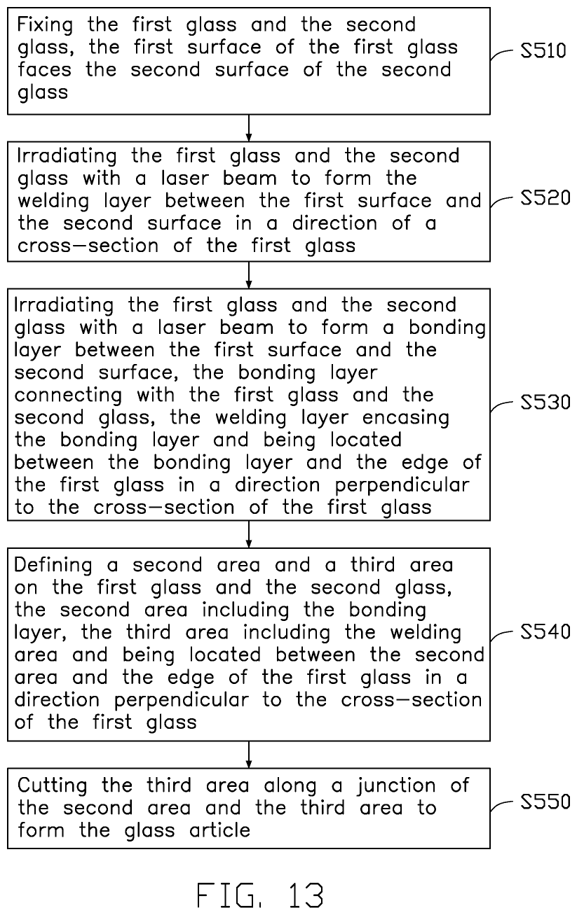

FIGS. 13 to 18 illustrate a method for manufacturing glass article 600 and 700 with improved stability of the laser welding of glasses. The method for manufacturing the glass articles 600 and 700 is configured to connect the first glass 100 and the second glass 20. The method for manufacturing the glass articles 600 and 700 includes the steps of:

Step S510, fixing the first glass 10 and the second glass 20, the first surface 11 of the first glass 10 faces the second surface 21 of the second glass 20;

Step S520, irradiating the first glass 10 and the second glass 20 with a laser beam to form the welding layer 40 between the first surface 11 and the second surface 21 in a direction of a cross-section of the first glass;

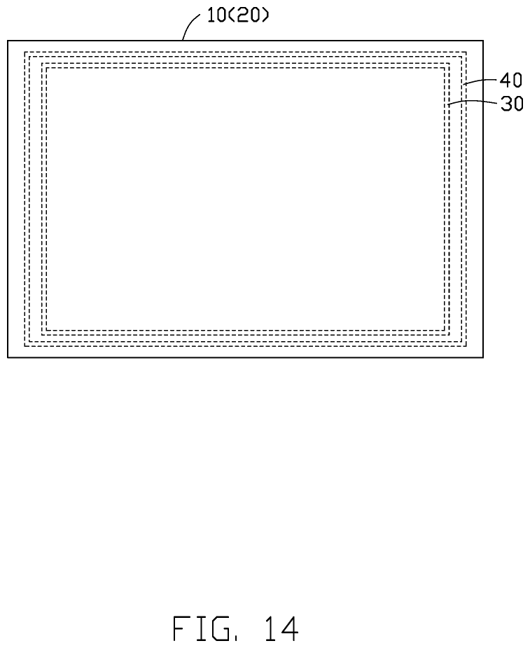

Step S530, irradiating the first glass 10 and the second glass 20 with a laser beam to generate a bonding structure between the first surface 11 and the second surface 21, the bonding structure is the bonding layer 30, the bonding layer 30 connecting with the first glass 10 and the second glass 20, the welding layer 40 being located between the bonding layer 30 and the edge of the first glass 10 in a direction perpendicular to the cross-section of the first glass (shown in FIG. 14);

Step S540, defining a second area 60 (160) and a third area 70 (170) on the first glass 10 and the second glass 20, the second area 60 (160) including the bonding layer 30, the third area 70 (170) being located between the second area 60 (160) and the edge of the first glass 10 in a direction perpendicular to the cross-section of the first glass;

Step S550, cutting the third area 70 (170) along a junction 80 (180) of the second area 60 (160) and the third area 70 (170) to form the glass article 600 (700).

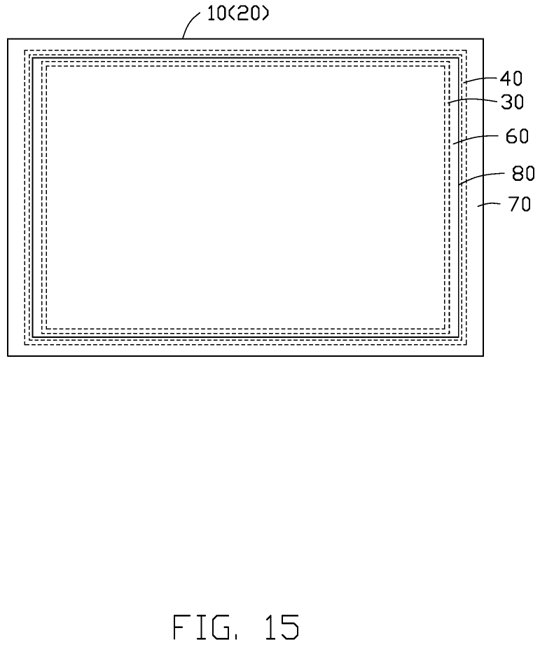

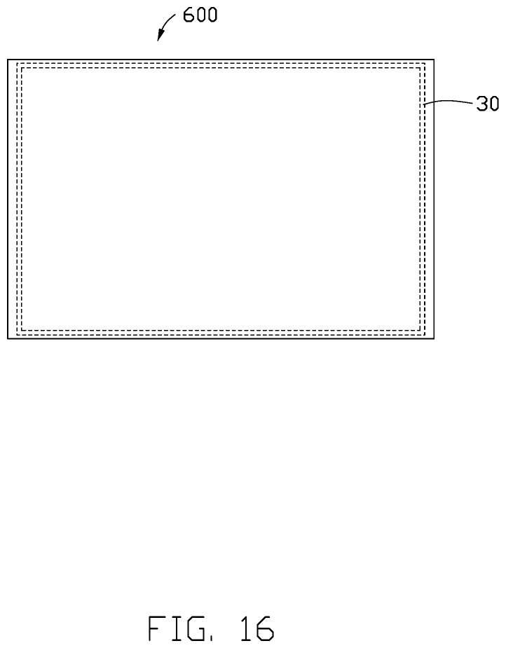

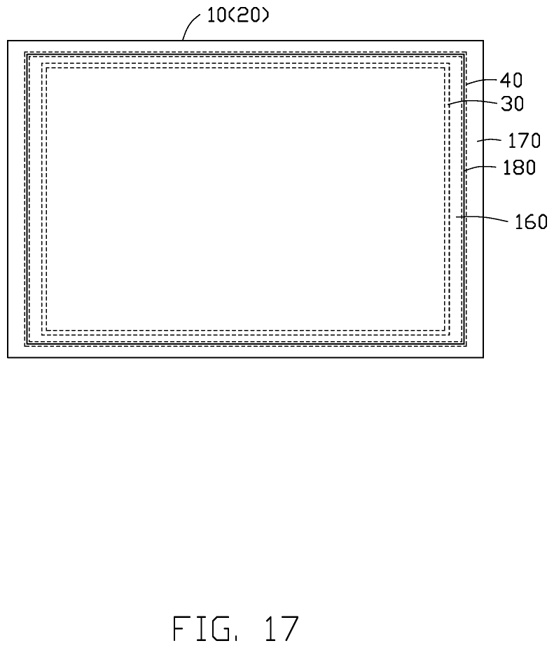

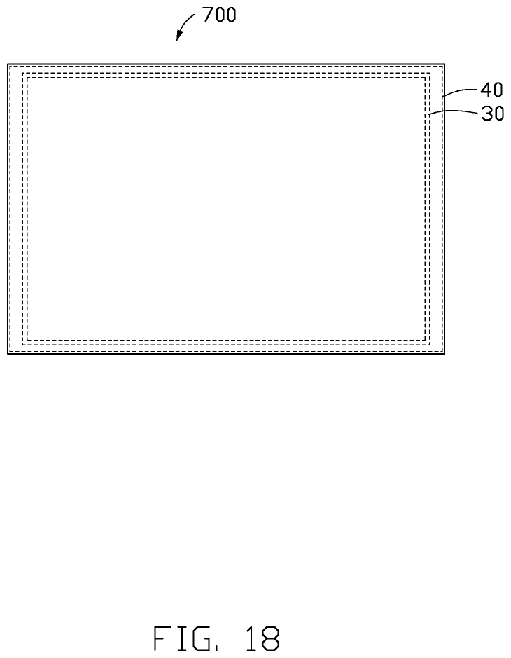

According to an embodiment, as FIG. 15 illustrates, the second area 60 may not include the welding layer 40 and the third area 70 can include the whole welding layer 40. The glass article 600 formed after cutting the third area 70. The glass article 600 does not include the welding layer 40 (shown in FIG. 16). According to other embodiment, as FIG. 17 illustrates, the second area 160 includes a part of the welding layer 40 and the third area 170 includes the remaining part of the welding layer 40, and the glass article 700 formed after cutting the third area 170 thereby includes a part of the welding layer 40 (shown in FIG. 18).

Specifically, in steps S520 and S530, the first glass 10 and the second glass 20 are irradiated by the laser beam emitted from a laser emitting device.

FIG. 20 illustrates a laser welding equipment, which works to combine the first glass 10 and the second glass 20, and includes a fixing device (not shown) and a laser emitting device 400.

The fixing device is configured to fix the first glass 10 and the second glass 20, so that the first surface 11 of the first glass 10 faces the second surface 21 of the second glass 20.

The laser emitting device 400 is configured to emit a laser beam penetrating through the first glass 10 and the second glass 20, thereby generating a bonding structure between the first surface 11 and the second surface 21, which is the bonding layer 30. The bonding layer 30 connects with the first glass 10 and the second glass 20 to form the glass article 100.

The laser emitting device 400 includes a femtosecond laser emitting tube 410. A pulse width of the femtosecond laser emitting tube 410 is less than 1000 fs.

The laser emitting device 400 further includes an optical component 420. The lens of the optical component 420 can bear an optical energy density greater than 150 mJ.

The optical component 420 may include a beam expander 421, a reflecting mirror 422, and a focusing mirror 423.

The beam expander 421 is configured to expand a diameter of the laser beam and reduce a divergence angle of the laser beam. The reflecting mirror 422 is configured to change a direction of the laser beam so that it irradiates the first glass 10 and the second glass 20. The focusing mirror 423 is configured to change a focus of the laser beam so that it is focused on the first surface 11 and the second surface 21.

According to an embodiment, the laser welding equipment includes an organic substance providing device, the fixing device, and the laser emitting device 400.

Specifically, the organic substance providing device is configured to provide an organic substance on at least one of the first surface 11 of the first glass 10 and the second surface 21 of the second glass 20. The organic substance may be provided only on the first surface 11 of the first glass 10, or may be provided only on the second surface 21 of the second glass 20, or may be provided on both of the first surface 11 of the first glass 10 and the second surface 21 of the second surface 20. According to an embodiment, when the organic substance is provided to both of the first surface 11 and the second surface 21, the sequence of providing the organic substance on the first surface 11 and the second surface 21 can be changed according to needs, for example, the organic substance may be provided on the first surface 11 first, and then provided on the second surface 21; or the organic substance may be provided on the second surface 21 first, and then provided on the first surface 11; or the organic substance may be provided on the first surface 21 and the second surface 21 at the same time. The fixing device is configured to fix the first glass 10 and the second glass 20 so that the first surface 11 of the first glass 10 faces the second surface 21 of the second glass 20. The organic substance is located between the first glass 10 and the second glass 20. The laser emitting device is configured to emit a laser beam penetrating through the first glass 10 and the second glass 20, thereby creating a bonding structure (bonding layer 30) between the first surface 11 and the second surface 21. The bonding layer 30 connects with the first glass 10 and the second glass 20 to form the glass article 100.

According to other embodiment, the laser welding equipment includes a fixing device (not shown), the laser emitting device 400, and a cutting device (not shown).

The fixing device is configured to fix the first glass 10 and the second glass 20 so that the first surface 11 of the first glass 10 faces the second surface 21 of the second glass 20.

The laser emitting device 400 is configured to emit a laser beam penetrating through the first glass 10 and the second glass 20, thereby further forming the welding layer 40 and the bonding layer 30 between the first surface 11 and the second surface 21. The bonding layer 30 connects with the first glass 10 and the second glass 20, the welding layer 40 is located between the bonding layer 30 and the edge of the first glass 10 in a direction perpendicular to the cross-section of the first glass.

The cutting device cuts the third area 70 to form the glass article 100. The third area 70 is located between the second area 60 and the edge of the first glass 10. The second area 60 includes the bonding layer 30.

In the glass fusion method in related art, the physical forms of the glasses are changed. However, in the method for manufacturing the glass article of the present disclosure, a bonding structure is formed between glasses through a multiphoton absorption effect generated by a laser, in which the chemical bond is broken and then re-formed. The resulting microscopic appearance is flat, and the weld marks are small.

In the present disclosure, no adhesive is needed to assist bonding, and the glass quality of the glass article is high.

While the present disclosure has been described with reference to particular embodiments, the description is illustrative of the disclosure and is not to be construed as limiting the disclosure. Therefore, those of ordinary skill in the art can make various modifications to the embodiments without departing from the scope of the disclosure as defined by the appended claims.

What is claimed is:

1. A glass article, comprising:
a first glass;
a second glass; and
a bonding layer located between the first glass and the second glass in a direction of a cross-section of the first glass;
wherein the first glass connects with the bonding layer, and the second glass connects with the bonding layer.

2. The glass article of claim 1, wherein the bonding layer comprises a first bonding unit and a second bonding unit;
a straight-line distance between a center of the first bonding unit and a center of the second bonding unit is a, and 5 μm≤a≤1000 μm.

3. The glass article of claim 1, wherein a thickness of the bonding layer in the first glass is b, b is greater than zero, and less than or equal to 90% of a thickness of the first glass.

4. The glass article of claim 1, wherein a thickness of the bonding layer in the second glass is c, c is greater than zero, and less than or equal to 90% of a thickness of the second glass.

5. The glass article of claim 1, wherein a thickness of the bonding layer in the first glass is b, and 0 μm<b<2000 μm.

6. The glass article of claim 1, wherein a thickness of the bonding layer in the second glass is c, and 0 μm<c≤2000 μm.

7. The glass article of claim 1, wherein the bonding layer comprises an organic substance.

8. The glass article of claim 7, wherein a ratio of a refractive index of the organic substance to a refractive index of the first glass is X, and 80%≤X≤120%.

9. The glass article of claim 7, wherein a ratio of a refractive index of the organic substance to a refractive index of the second glass is Y, and 80%≤Y≤120%.

10. The glass article of claim 7, wherein the organic substance comprises an organic liquid with a carbon number not greater than 10.

11. The glass article of claim 7, wherein a content of the organic substance is A, and 8×10⁻⁷ g/mm²≤A≤1×10⁻⁴ g/mm².

12. The glass article of claim 1, further comprising a welding layer;
wherein the welding layer is located between the first glass and the second glass in the direction of the cross-section of the first glass; and
the welding layer is located between the bonding layer and an edge of the first glass in a direction perpendicular to the cross-section of the first glass.

13. The glass article of claim 12, wherein a shortest straight-line distance between the welding layer and the edge of the first glass is x, and 0 μm≤x≤1000 μm.

14. A method for manufacturing a glass article to combine a first glass and a second glass, the method comprising:
fixing the first glass and the second glass, wherein a first surface of the first glass faces a second surface of the second glass;
irradiating the first glass and the second glass with a laser beam to form a bonding layer between the first surface and the second surface in a direction of a cross-section of the first glass, the bonding layer connecting with the first glass and the second glass to form the glass article.

15. The method of claim 14, wherein the irradiating the first glass and the second glass with a laser beam comprising:
adjusting a laser irradiation position so that the laser beam penetrates through the first glass and the second glass;
adjusting a focus depth of the laser beam so that a focus of the laser beam is located on the first surface and the second surface; and
moving the laser beam along a path to scan the first surface and the second surface.

16. The method of claim 14, further comprising:
providing an organic substance on at least one of the first surface and the second surface to locate the organic substance between the first glass and the second glass.

17. The method of claim 14, further comprising:
irradiating the first glass and the second glass with a laser beam to form a welding layer between the first surface and the second surface, so that the welding layer encasing the bonding layer and the welding layer being located between the bonding layer and an edge of the first glass in a direction perpendicular to the cross-section of the first glass;
defining a second area and a third area, the second area comprising the bonding layer, the third area comprising the welding layer, and the third area being located between the second area and the edge of the first glass in a direction perpendicular to the cross-section of the first glass;
cutting the third area to form the glass article.

18. A laser welding equipment configured to combine a first glass and a second glass, the laser welding equipment comprising:
a fixing device configured to fix the first glass and the second glass, so that a first surface of the first glass faces a second surface of the second glass; and
a laser emitting device configured to emit a laser beam which penetrates through the first glass and the second glass to form a bonding layer between the first surface and the second surface, and the bonding layer connects with the first glass and the second glass to form a glass article;
wherein the laser emitting device comprises a femtosecond laser emitting tube.

19. The laser welding equipment of claim 18, wherein a pulse width of the femtosecond laser emitting tube is less than 1000 fs;
the laser welding equipment further comprises an optical component, and lens of the optical component bear an optical energy density greater than 150 mJ.

20. The laser welding equipment of claim 18, further comprising:
an organic substance providing device configured to provide an organic substance on at least one of the first surface and the second surface.
